(19) United States
(12) Patent Application Publication
(10) Pub. No.: US 2025/0094843 A1
(43) Pub. Date: Mar. 20, 2025

(54) Computer-Implemented Data Structure, Method and System for Operating a Technical Device with a Model Based on Federated Learning

(71) Applicant: Siemens AG Österreich, Wien (AT)

(72) Inventor: Daniel SCHALL, Hollabrunn (AT)

(21) Appl. No.: 18/729,354

(22) PCT Filed: Jan. 18, 2023
(86) PCT No.: PCT/EP2023/051145

§ 371 Date: Jul. 16, 2024

(30) Foreign Application Priority Data
Jan. 18, 2022 (WO) PCT/EP2022/051043

(51) Int. Cl. G06N 7/01

(52) U.S. Cl. CPC G06N 7/01

(57) ABSTRACT

A computer-implemented method for operating a technical device which is connected to a client of a client-server system that includes a server and connected clients that at least temporarily interact with the server, which is captured as interactions, with a model based on federated learning, wherein a reliability factor, a reaction time factor and ca quality-of-information factor are captured, a trust factor formed as a Bayesian network is determined for each of the clients, local models in each of the clients are trained, the trained local models are transmitted from each of the clients to the server, the transmitted local models of each of the clients are aggregated into a global model by applying the relevant trust factor to each local model, the global model is transmitted from the server to the client, and the technical device is controlled aided by the global model.

### CROSS-REFERENCE TO RELATED APPLICATIONS

This is a U.S. national stage of application No. PCT/EP2023/051145 filed 18 Jan. 2023. Priority is claimed on International Application No. PCT/EP2022/051043 filed 18 Jan. 2022, the content of which is incorporated herein by reference in its entirety.

### BACKGROUND OF THE INVENTION

### 1. Field of the Invention

The invention relates to a computer-implemented data structure and a use of the data structure for a client on the edge of a client-server system for operating a technical device connected to a client on the edge with a model based on federated learning, a computer-implemented method and a system for operating the technical device with the model based on federated learning, a computer program, an electronically readable data carrier and also relates to a data carrier signal.

### 2. Description of the Related Art

“Federated Learning” (FL) is a machine learning technique that trains an algorithm across multiple decentralized edge devices that hold local data samples without exchanging the actual data.

This approach is in contrast to conventional centralized machine learning techniques in which all local data sets are uploaded to a server.

Federated learning enables multiple actors to build a common robust machine learning model without exchanging data, thus making it possible to address critical issues, such as data protection, data security, data access rights and access to heterogeneous data.

Federated learning requires a large number of devices to frequently exchange their learned model updates resulting in a significant communication overhead. This poses a major challenge in FL compared to realistic networks, which are limited in terms of computational and communication resources. Therefore, a subset of clients is frequently selected in order to minimize the devices participating in FL tasks.

Earlier works mainly concentrated on non-IID (“independent and identically distributed”) cases in which the training data of a specific client, such as a mobile telephone, is typically based on the usage of the mobile device by a specific user and therefore a user's local dataset is not representative of a population distribution.

In other words, contributions of individual clients, i.e., weights of locally trained models, are not always treated equally, but are weighted in an aggregation process.

Existing systems and previous works do not address data quality issues or the selection of devices based on previous client-server interactions or trust.

Client-server interactions, or interactions for short, refer, for example, to data communications between a client and a server. The data can be user data, such as sensor data, or control data for controlling a client or a device connected to a client.

The publication AMIT PORTNOY ET AL: “Towards Federated Learning with Byzantine-Robust Client Weighting”, ARXIV. ORG, CORNELL UNIVERSITY LIBRARY, 201 OLIN LIBRARY CORNELL UNIVERS ITY ITHACA, NY 14853, May 18 2021 (2021-05-18), XP081949237 discloses a client-server system for operating a device with a model based on federated learning comprising a trust factor for the device, which comprises a reliability factor and a quality-of-information factor. However, the trust factor has only low information density and is determined and stored centrally. Therefore, the solution only introduces a slight improvement.

The publication THOMAS HIESSL ET AL: “Industrial Federated Learning-Requirements and system Design”, ARXIV. ORG, CORNELL UNIVERSITY LIBRARY, 201 OLIN LIBRARY CORNELL UNIVERSITY ITHACA, NY 14853, May 14 2020 (2020-05-14), XP081673589, relates to a method for operating a device on a client of a client-server system with a model based on federated learning. However, the system does not take into account dynamic changes in the models in the context of federated learning and is therefore inadequate.

### SUMMARY OF THE INVENTION

In view of the foregoing, it is therefore an object of the invention to further improve the aggregation process for data in federated learning and to take into account operational characteristics of the clients.

The operational characteristics should take into account not only the initial operation, but also the current operation and should therefore also comprise dynamic adaptations of the model for operating the device.

The objects and advantages are achieved in accordance with the invention by a data structure comprising a trust factor for the device, which has a reliability factor, a response time factor and a quality-of-information factor for taking into account the data quality of the model for the data of the model, and the trust factor (T) is structured as a model formed as a Bayesian network, where the trust factor is provided for applying a weighting of the model of the technical device by the client during ongoing operation of the system.

The term “trust” can be defined as an agent's belief in attributes such as response time, reliability and competence in terms of the quality of information provided by a trustworthy agent. To model trust in an IoT edge-based network, a naive Bayes classifier approach is provided.

A Bayesian network or Bayes network is a relationship network that uses statistical methods to represent probability relationships between different elements, in particular conditional probabilities.

A Bayesian network is a directed acyclic graph in which the nodes represent random variables and the edges represent conditional dependencies between the variables. Each node of the network is assigned a conditional probability distribution of the random variable it represents, given the random variables at the parent nodes. They are described by probability tables. This distribution can be arbitrary, but discrete or normal distributions are often used. Parents of a node v are the nodes from which an edge leads to v.

A Bayesian network is used to represent the joint probability distribution of all variables involved as compactly as possible using known conditional independencies. Herein, the conditional (in) dependence of subsets of the variables is combined with the a priori knowledge.

A data structure based on a Bayesian network is therefore particularly favorable for storing probabilities as compactly as possible. This is particularly favorable if the data is transferred or stored in a data network, such as between clients and servers.

A naive Bayesian network is a simple Bayesian network, i.e., a directed graph that represents conditional dependencies.

It consists of a root node and several leaf nodes. A naive Bayesian network is used to represent the trust between two nodes, such as between a server and a client in a favorable way.

Herein, three trust aspects are taken into account in a trust factor (“trust in IoT node”), i.e., reliability, response time and quality of information.

Reference is made to the fact that, in the present context, the term “factor” is used for the sake of simplicity, even though the trust factor is a model in the form of a Bayesian network and hence is not a scalar in the present context. Alternatively, the term “trust model” can be used as the equivalent of the term “trust factor”.

The trust factor describes the trust of a server in a client and can change dynamically during the operation of the client-server system.

The trust factor describes the trust in the device in the form of a numerical evaluative factor.

The trust factor can be calculated by a corresponding computing apparatus in a client or in the server, where calculation in the server is advantageous, because the same constituent computing apparatus can be used for several clients and the system is therefore simpler overall.

The trust factor of a client can change over time, for example, if the data connection deteriorates during the operation of the system and thus has an unfavorable effect on the quality-of-information factor.

A client can also take active measures, for example, in order to improve the response time, if the client itself has established that the trust of a server is too low by establishing an alternative data connection with a short response time.

Reliability is the ability of a system or component to function under specified conditions for a specific period of time. It is important for an accurate ML model that IoT nodes provide services that are available and can be relied upon. This includes, for example, the availability of a client to join a federation.

The reliability factor describes the reliability of a client in relation to a server, based on the network communication behavior between client and server.

The reliability factor describes the reliability of the device in the form of a numerical evaluative factor.

The reliability factor is advantageously calculated in the server because the same constituent computing apparatus can be used in the server for several clients and the system is therefore simpler overall.

The response time is the time difference between requesting information and receiving a response to the request. It is important for an accurate ML model that IoT nodes respond promptly to requests.

The response time factor describes the temporal behavior of a client in relation to a server based on the network communication behavior between client and server.

The response time factor describes the temporal behavior of the device in the form of a numerical evaluative factor.

The response time factor is advantageously calculated in the server because the same constituent computing apparatus can be used in the server for several clients and the system is therefore simpler overall.

Quality-of-information should, for example, be understood to mean the accuracy, completeness, consistency, up-to-dateness, validity and uniqueness of the information. It is important for an accurate ML model that the models are trained with the aid of high-quality data.

The quality-of-information factor describes the quality-of-information of a client's data supplied to a server.

The quality-of-information factor describes the quality-of-information of data supplied by the device in the form of a numerical evaluative factor.

The quality-of-information factor is advantageously calculated in the server, where the metrics used for this are determined based on raw data in the client.

These metrics can be transmitted to the server, which then calculates the quality-of-information factor by a constituent computing apparatus.

Further relevant aspects can be added later in the Bayesian network in order to take future preferences into account.

A model based on this advantageous approach in the form of a computer-implemented data structure is very simple and easy to implement and fast and particularly compact in terms of low memory requirement and favorable access characteristics. This in particular enables it to be implemented on various embedded resource-constrained devices.

Furthermore, less training data is required. In the prior art, other ML techniques such as SVM, RF, NN, DNN typically require large amounts of data and models and therefore usually must be trained in the cloud, because this is only place where corresponding resources are available. The new approach now enables the models to be trained and updated directly on the edge device.

Moreover, a model based on this approach is highly scalable, because it is linearly scaled with the number of predictors and data points, which is an important characteristic for supporting calculations on IoT nodes.

In an embodiment of the invention, the weighting of the model of the device is dynamically redetermined over time during the operation of the system.

This ensures that an up-to-date model is always available in the respective client and that interactions can always be re-evaluated and thus a global model for federated learning can be kept up to date.

In another embodiment of the invention, the data structure in accordance with the invention is computer-implemented in a client of the client-server system.

This ensures that conditional probabilities characterizing interactions of a client-server system can be stored very compactly.

Interactions can, for example, be captured by data loggers. Herein, it is possible to capture the content of a data transfer, but it is also possible to determine transfer characteristics, such as latency, transfer error rate, transfer bandwidth, data packet time stamp information, data loss rates, and/or number of transfer repetitions.

As described above, the interactions can be captured and evaluated in both the server and a client, for example, with the aid of a data logger or simple statistical evaluations of data transfers between one or more clients and the server.

If a respective trust factor is determined in a client, then the client has the option of deriving measures for the client itself from the captured and evaluated interactions, for example, in order to take measures that lead directly to the ability to improve the parameters and hence to offer “better” interactions to the server.

If the trust factor of a client is determined in the server, then this trust factor can be transmitted to the corresponding client so that the client is informed about the status of its trust factor and can take appropriate measures to change it.

The trust factor can be transmitted to a client periodically or, for example, can be initiated by a change above a predefined threshold.

In a further embodiment of the invention, the reliability factor is based on the availability of the technical device during the operation of the system.

This ensures that only available clients or their connected devices can influence the global model.

In another embodiment of the invention, the response time factor is based on the time difference between requesting information and receiving a response to the request for the device during the operation of the system.

This ensures that clients with correspondingly low latency can influence the global model to a greater extent than slow clients.

In an embodiment of the invention, the quality-of-information factor is based at least on the accuracy, completeness, consistency, up-to-dateness, validity or uniqueness of the information for the technical device during the operation of the system.

This ensures that clients with correspondingly high data quality can influence the global model to a greater extent than less accurate clients.

The objects and advantages are achieved in accordance with the invention by using the data structure for a computer-implemented method for operating a technical device by a client of a client-server system with a model based on federated learning.

The data structure can be used to improve the internal processes of the FL client-server architecture by making greater use of favorable system characteristics and suppressing unfavorable system characteristics accordingly.

The objects and advantages are also achieved in accordance with the invention by a computer-implemented method for operating a technical device that is connected to a client of a client-server system, where the client-server system comprises a server and connected clients and the clients interact at least temporarily with the server, which is captured as interactions, with a model based on federated learning, the method includes:
a) capturing a reliability factor that is based on the availability of the technical device during the operation of the system and that is ascertained from the captured interactions in step a),
b) capturing a response time factor that is based on the time difference between requesting information and receiving a response to the request for the device during the operation of the system and that is ascertained from the captured interactions in step a),
c) capturing a quality-of-information factor that is based at least on the accuracy, completeness, consistency, up-to-dateness, validity or uniqueness of the information for the technical device during the operation of the system and that is ascertained from the captured interactions in step a),
d) determining by the client of a respective trust factor, which is structured as a model formed as a Bayesian network, for the clients, which is formed from the reliability factor, the response time factor and the quality-of-information factor with the aid of factors for respective probabilities,
e) training local models in the respective client, f) transmitting the local models trained in the preceding step from the respective client to the server,
g) aggregating by the server of the local models of the respective clients transmitted in the preceding step into a global model by applying the respective trust factor to the respective local model, and
h) transmitting the global model from the server to the client and actuating the technical device with the aid of the global model.

This can ensure very efficient operation of the technical device without the need for extensive local training. An accurate and advantageous global model can be used, even if a new client is taken into account in the system.

The advantages of the data structure according to the invention are equally retained in the method in accordance with the invention.

In another embodiment of the invention, the respective trust factor is redetermined in the ongoing operation of the system and data captured more recently with respect to the reliability factor, the response time factor and the quality-of-information factor is weighted more heavily than older data.

This means that new up-to-date data can exert a correspondingly greater influence on the global model and older data is removed from the system again. As a result, the FL system responds very dynamically to up-to-date changes.

The objects and advantages are further achieved in accordance with the invention by a system comprising a server and connected clients, which are each connected to technical devices, where the system is configured to execute the method in accordance with the invention.

The objects and advantages are also achieved in accordance with the invention by a computer program comprising instructions which, when executed by a computer, cause the computer to execute the method in accordance with the invention on the system in accordance with the invention.

The objects and advantages are also achieved in accordance with the invention by an electronically readable data carrier with readable control information stored thereon, which comprises at least the computer program in accordance with the invention and is configured such that, when the data carrier is used in a computing facility, it performs the method in accordance with the invention.

The objects and advantages are also achieved in accordance with the invention by a data carrier signal which transfers the computer program in accordance with the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below with reference to an exemplary embodiment depicted in the accompanying drawings, in which:

FIG. 1 shows a Federated Learning (FL) loop in accordance with the prior art;

FIG. 2 shows an exemplary trust factor data structure in accordance with the invention;

FIG. 3 shows an exemplary apparatus in accordance with the invention,

FIG. 4 shows an exemplary embodiment of a method in accordance with the invention,

FIG. 5 shows an exemplary calculation of the trust factor in the form of a pseudo-code,

FIG. 6 shows an exemplary federated averaging in the form of a pseudo-code.

### DETAILED DESCRIPTION OF THE EXEMPLARY EMBODIMENTS

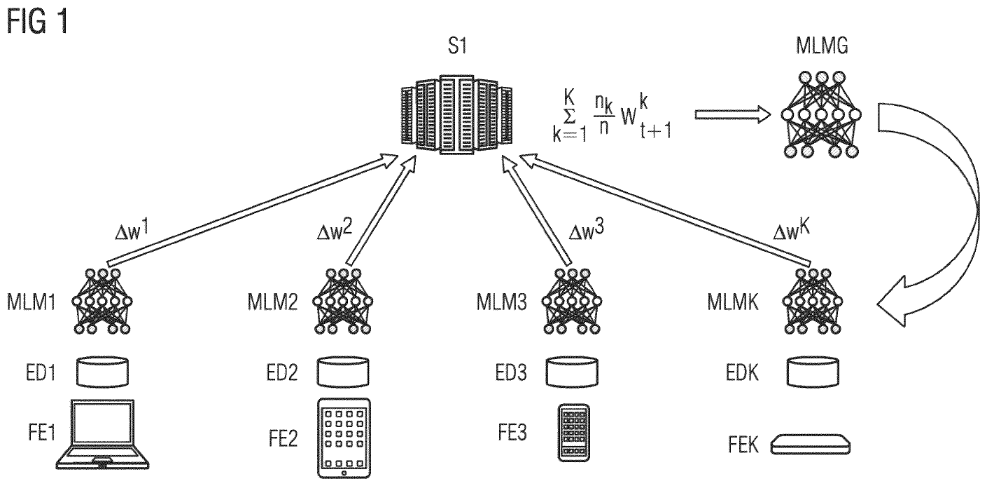

FIG. 1 shows a Federated Learning (FL) loop in accordance with the prior art.

Herein, clients ED1, ED2, ED3, EDK with connected devices FE1, FE2, FE3, FEK (“front end”) have corresponding weights within respective local models MLM1, MLM2, MLM3, MLMK which are transferred to a server S1.

The server S1 performs an aggregation of the models MLM1, MLM2, MLM3, MLMK received from the clients ED1, ED2, ED3, EDK with a federated averaging algorithm and forms a global model MLMG with corresponding weights.

The server S1 distributes the resulting averaged weights back to the clients ED1, ED2, ED3, EDK.

The clients can now actuate or operate the connected technical devices ED1, ED2, ED3, EDK with the aid of the new ML model, for example, in order to perform predictive maintenance on the device.

This loop is repeated for N communication rounds.

Contributions of individual clients, i.e., weights of locally trained models, are not treated equally, but weighted in an aggregation process.

This aspect nₖ/n is shown in the FIG. 1, where n is the number of data examples and nₖ is the number of data examples of the client k.

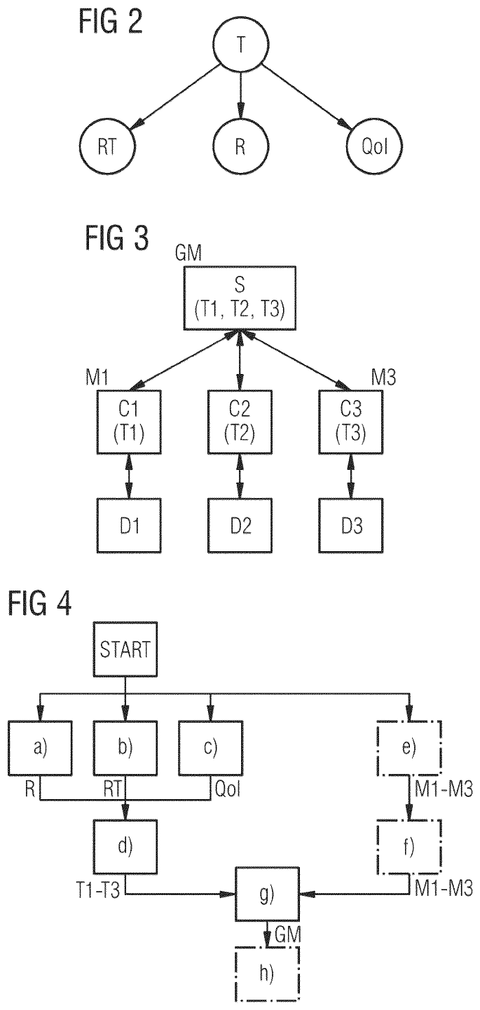

FIG. 2 is a graphical depiction of an exemplary trust factor data structure in accordance with the invention that is applied in an FL model.

A trust factor T (“trust in IoT node”) is determined by a reliability factor R, a response time factor RT and a quality-of-information factor QoI.

FIG. 3 shows an exemplary apparatus in accordance with the invention with a server S and clients C1-C3, which are configured to interact with respective technical devices D1, D2, D3.

Each client C1, C2, C3, also referred to as an edge device, has a computer-implemented data structure in the form of a trust factor T1-T3 according to the preceding figure, and of course a respective local trained ML model for operating of the connected device D1-D3 in each case. It should be understood the edge devices include a processor and memory. Such device are manufactured by the company Siemens, such as a SIMATIC IPC127E Industrial Edge Device.

The server S has an aggregated global ML model GM which is provided to the clients C1, C2, C3.

The trust factors T1, T2, T3 are ascertained by the server from interactions, such as data transactions between the server S and clients C1, C2, C3, and stored in the server.

Alternatively, however, the trust factors T1, T2, T3 can also be stored in the clients C1-C3, wherein the trust factors T1, T2, T3 are each transferred with the trained local models M1, M2, M3 in order then to be aggregated to the global model GM in the server S.

Therefore, the trust factor T1, the local model M1 and the technical device D1 are assigned to the client C1.

The trust factor T2, the local model M2 and the technical device D2 are assigned to the client C2.

The trust factor T3, the local model M3 and the technical device D3 are assigned to the client C3.

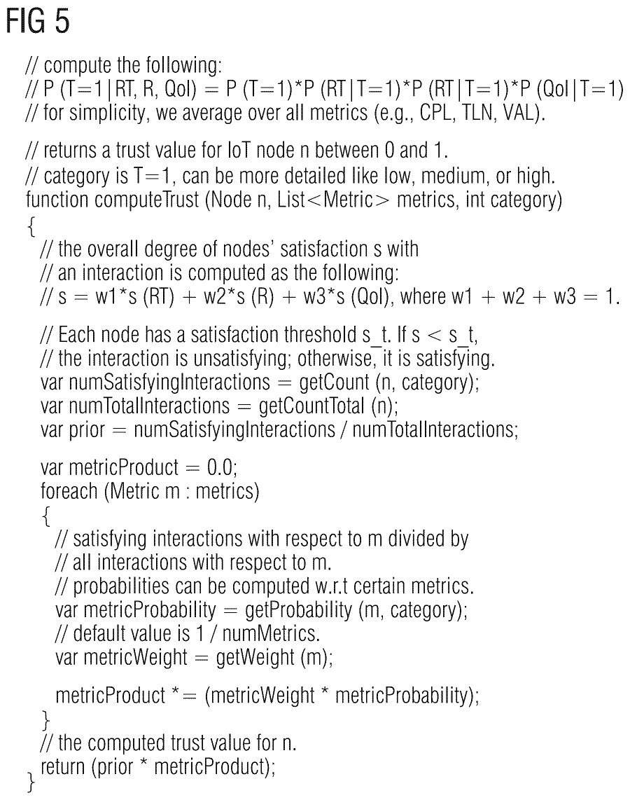

FIG. 4 shows an exemplary embodiment of the method in accordance with the invention for operating a technical device D1, D2, D3, which is connected to a client C1, C2, C3 of a client-server system, where the client-server system comprises a server S and connected clients C1, C2, C3 and the clients C1, C2, C3 interact at least temporarily with the server S, which is captured as interactions, with a model based on federated learning, the methods includes:
a) capturing by the client C1, C2, C3 of a reliability factor R that is based on the availability of the technical device D1, D2, D3 during the operation of the system and that is ascertained from the captured interactions,
b) capturing by the client C1, C2, C3 of a response time factor RT that is based on the time difference between requesting information and receiving a response to the request for the device during the operation of the system and that is ascertained from the captured interactions,
c) capturing by the client C1, C2, C3 of a quality-of-information factor QoI, which is based at least on the accuracy, completeness, consistency, up-to-dateness, validity or uniqueness of the information for the technical device D1, D2, D3 during the operation of the system and that is ascertained from the captured interactions,
d) determining by the client C1, C2, C3 of a respective trust factor T1, T2, T3 that is structured as a model formed as a Bayesian network, for the clients C1, C2, C3, which is formed from the reliability factor R, the response time factor RT and the quality-of-information factor QoI with the aid of factors for respective probabilities CRT,
e) training local models M1, M2, M3 in the respective clients C1, C2, C3,
f) transmitting the local models of the respective clients C1, C2, C3 trained in the preceding step from the respective clients C1, C2, C3 to the server S,
g) aggregating by the server S of the local models M1, M2, M3 of the respective clients C1, C2, C3 transmitted in the preceding step into a global model GM by applying the respective trust factor T1, T2, T3 to the respective local model,
h) transmitting the global model from the server S to the client C1 and actuating the technical device D1 with the aid of the global model GM.

In step d), the quality-of-information factor QoI can be determined with the aid of further metrics CRT (“conditional probability table”) that comprises conditional probabilities in the form of a table, where each leaf node is linked via the metric elements in the form of a table.

It is identifiable from FIG. 4 that steps a) to d) can also be executed temporally independently from steps e) and f), i.e., also in parallel, as depicted.

Interaction of a client with the server should be understood to mean communication or data transport, such as to communicate data from an end device in the form of a sensor connected to a client to the server. A client can also be considered to be a root node.

Each trust factor T1-T3 can have two values as root nodes, i.e., “1” for “satisfactory” or “0” for “unsatisfactory”.

A value P (T) represents the server's overall trust in a client, i.e., an IoT node, in the ability to provide usable knowledge in the form of trained weights.

The value is determined by the ratio of “satisfactory” interactions to the total number of interactions.

A value P (T=1) means that “only satisfactory” interactions have been ascertained.

A value P (T=0) means that “no satisfactory” interactions have been ascertained.

It will be demonstrated below that the table CPT for the quality-of-information factor QoI, the response time factor RT and the reliability factor R are defined similarly.

The node of the quality-of-information factor QoI represents a set of different data quality metrics DOM.

In this exemplary embodiment, the quality-of-information factor QoI comprises three metric values:
completeness CPL: refers to the completeness of data with respect to all values as a part and in total. Accordingly, there should be no gaps in the data and no information should be missing. In other words, the data should contain absolutely all the intended information.
timeliness TIN: data should be up to date and available on the server at the intended retrieval time and corresponding access should also be possible.
validity VAL: validity refers to how accurately a method measures what it is supposed to measure. This means that it provides results that correspond to the real characteristics, characteristics and variations in the physical world.

The data quality metrics DOM are determined in the client from raw data of an IoT device connected to the client, transferred to the server and can, for example, by summation, form the quality-of-information factor QoI that is calculated in the server.

Other data aggregations are also possible that, for example, take into account weightings of individual metrics.

Hence, through the data quality metrics DOM, the quality-of-information factor QoI itself comprises a Bayesian network.

Table 1 shows examples of data quality metrics DOM.

TABLE 1
Data quality metrics DQM

| DQM | T = 1 | T = 0 |
|---|---|---|
| CPL | P (QoI = “CPL” \| T = 1) | P (QoI = “CPL” \| T = 0) |
| TLN | P (QoI = “TLN” \| T = 1) | P (QoI = “TLN” \| T = 0) |
| VAL | P (QoI = “VAL” \| T = 1) | P (QoI = “VAL” \| T = 0) |

FIG. 5 shows an example for calculating the trust factor in the form of a pseudo-code.

Data quality metrics DOM are calculated by the relationship:

$$P ( T = 1 \vert RT , R , QoI ) = P ( T = 1 ) * P ( RT \vert T = 1 ) * P ( RT \vert T = 1 ) * P ( QoI \vert T = 1 ) .$$

For the sake of simplicity, all metrics such as CPL, TLN and VAL are averaged.

The result of this calculation provides a trust value for an IoT node between 0 and 1.

A function computeTrust( ) is defined which provides an overall degree of “satisfaction” s with an interaction between the server S and a client C1-C3, and is determined via the relationship:

$$s = w 1 * s ( RT ) + w 2 * s ( R ) + w 3 * s ( QoI )$$

$$where$$

$$w 1 + w 2 + w 3 = 1.$$

Each node has a threshold s_t for a “satisfactory” interaction.

If s<s_t, the interaction is “unsatisfactory”, otherwise the interaction is “satisfactory”.

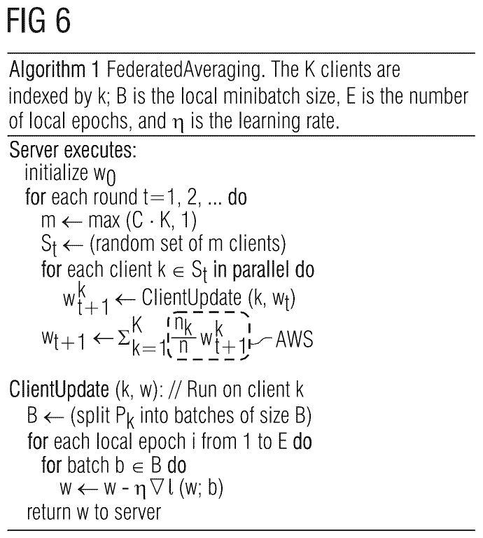

FIG. 6 shows an example of federated averaging in the form of a pseudo-code “FederatedAveraging”.

This exemplary embodiment shows an exemplary extension of the approach, where a possibility for “ageing” the trust factor is provided.

Similarly to human ageing, certain types of knowledge can be “forgotten”, for example, over time. In other words, therefore, knowledge relating to trust can age.

This characteristic is particularly relevant and advantageous for a dynamic IoT environment.

For example, the sensor measurement apparatus connected to an IoT node can be renewed and improved and hence provide more accurate estimates resulting in a favorable impact on the quality-of-information factor QoI.

Therefore, the ability of individual IoT nodes to provide valuable information may well change depending on environmental factors.

Due to the changes in the environment, it can be advantageous to apply the aforementioned “ageing” concept and to forget historically older values, i.e., to remove them again from a calculation set or data set.

This ageing can be applied to the metrics for the quality-of-information factor QoI, the response time factor RT and the reliability factor R either individually or to all of them together, for example, by applying higher weighting to more recent data and lower weighting to older data.

P(T=1) can be calculated using the following relationship:

$$\begin{matrix}P ( T = 1 ) = {( num\_satisfying / num\_interactions )}_{t} + \\ + ( 1 - α ) * {( num\_satisfying / num\_interactions )}_{t - 1} + \\ + {( 1 - α )}^{2} * {( num\_satisfying / num\_interactions )}_{t - 2}\end{matrix}$$

The number of favorable interactions between the server S and a client C1, C2, C3 at the same time slot t is characterized by the ratio of num_satisfying/num_interactions.

The value “num_satisfying” denotes the number of “satisfactory” interactions and the value “num_interactions” the actual number of interactions.

An ageing factor a is between 0 and 1, where, in this case more recent interactions or their degree of “satisfaction” is/are weighted higher than older interactions.

Therefore, an adaptive weighting scheme AWS is applied in the federated averaging algorithm “FederatedAveraging”.

In FIG. 6, the weight term weights wₜ₊₁^{k} is marked. The set of weights wₜ₊₁^{k} of a model of a client k is multiplied by the trust weight w_{T}, where the trust weight w can be determined by the function computeTrust( ) shown in the preceding figure.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A computer-implemented data structure for a client at an edge of a client-server system for operating a technical device connected to a client at the edge with a model based on federated learning, comprising:
a trust factor for the technical device, the trust factor having a reliability factor, a response time factor and a quality-of-information factor for taking into account data quality of the model for the data of the model, and the trust factor formed embodied as a model comprising a Bayesian network;
wherein the trust factor is provided for applying a weighting of the model of the technical device by the client during ongoing operation of the system.

15. The computer-implemented data structure as claimed in claim 14, wherein the weighting of the model of the technical device is dynamically redetermined over time during the operation of the system.

16. The computer-implemented data structure as claimed in claim 14, wherein the data structure is computer-implemented in a client of the client-server system.

17. The computer-implemented data structure as claimed in claim 14, wherein the reliability factor is based on an availability of the technical device during the operation of the system.

18. The computer-implemented data structure as claimed in claim 14, wherein the response time factor is based on a time difference between requesting information and receiving a response to the request for the technical device during the operation of the system.

19. The computer-implemented data structure as claimed in claim 14, wherein the quality-of-information factor is based at least on an accuracy, completeness, consistency, up-to-dateness, validity or uniqueness of information for the technical device during the operation of the system.

20. The computer-implemented data structure as claimed in claim 14, wherein the computer-implemented is utilized to operate the technical device via a client of a client-server system with a model based on federated learning.

21. A computer-implemented method for operating a technical device connected to a client of a client-server system, the client-server system comprising a server and connected clients which interact at least temporarily with the server, which is captured as interactions, with a model based on federated learning, the method comprising:
a) capturing, by the client, a reliability factor which is based on an availability of the technical device during operation of the client-server system and which is ascertained from the captured interactions;
b) capturing, by the client, a response time factor which is based on a time difference between requesting information and receiving a response to the request for the technical device during the operation of the client-server system and which is ascertained from the captured interactions;
c) capturing, by the client, a quality-of-information factor which is based at least on an accuracy, completeness, consistency, up-to-dateness, validity or uniqueness of information for the technical device during the operation of the system and which is ascertained from the captured interactions;
d) determining, by the client, a respective trust factor which is formed as a model comprising a Bayesian network, for the clients, which is formed from the reliability factor, the response time factor and the quality-of-information factor aided by factors for respective probabilities;
e) training local models in respective clients;
f) transmitting the trained local models from the respective client to the server;
g) aggregating, by the server, the transmitted local models of the respective clients into a global model by applying the respective trust factor to the respective local model; and
h) transmitting the global model from the server to the client and actuating the technical device aided by the global model.

22. The method as claimed in claim 21, wherein the trust factor is redetermined during ongoing operation of the client-server system and data captured more recently with respect to the reliability factor, the response time factor and the quality-of-information factor is weighted more heavily than older data.

23. A system for operating a technical device with a model based on federated learning, comprising:
a server; and
clients connected to the server, the clients each being connected to technical devices;
wherein the system is configured to:
a) capture, by the client, a reliability factor which is based on an availability of the technical device during operation of the client-server system and which is ascertained from the captured interactions;
b) capture, by the client, a response time factor which is based on a time difference between requesting information and receiving a response to the request for the technical device during the operation of the client-server system and which is ascertained from the captured interactions;
c) capture, by the client, a quality-of-information factor which is based at least on an accuracy, completeness, consistency, up-to-dateness, validity or uniqueness of information for the technical device during the operation of the system and which is ascertained from the captured interactions;
d) determine, by the client, a respective trust factor which is formed as a model comprising a Bayesian network, for the clients, which is formed from the reliability factor, the response time factor and the quality-of-information factor aided by factors for respective probabilities;
e) train local models in respective clients;
f) transmit the trained local models from the respective client to the server;
g) aggregate, by the server, the transmitted local models of the respective clients into a global model by applying the respective trust factor to the respective local model; and
h) transmit the global model from the server to the client and actuate the technical device aided by the global model.

24. A computer program comprising instructions which, when executed by a computer, cause the computer to execute the method as claimed in claim 21 on the system.

25. A non-transitory electronically readable data carrier encoded with readable control information stored thereon, which comprises at least the computer program as claimed in claim 21 and which, when utilized in a computing facility, performs the method as claimed in claim 21.

26. A data carrier signal which transfers the computer program as claimed in claim 24.
